(19) United States
(12) Patent Application Publication
(10) Pub. No.: US 2023/0145286 A1
(43) Pub. Date: May 11, 2023

(54) VEHICLE MANAGEMENT SYSTEM, SERVER, VEHICLE, AND VEHICLE MANAGEMENT METHOD

(71) Applicant: TOYOTA JIDOSHA KABUSHIKI KAISHA, Toyota-shi (JP)

(72) Inventor: Yu NAGATA, Tokyo (JP)

(73) Assignee: TOYOTA JIDOSHA KABUSHIKI KAISHA, Toyota-shi (JP)

(21) Appl. No.: 17/943,647

(22) Filed: Sep. 13, 2022

(30) Foreign Application Priority Data
Nov. 11, 2021 (JP) 2021-183945

(51) Int. Cl. G06F 8/65; B60W 50/00

(52) U.S. Cl. CPC G06F 8/65; B60W 50/00; B60W 2556/45; B60W 60/001

(57) ABSTRACT

A vehicle management system includes a vehicle configured to perform autonomous driving, and a control center configured to perform wireless communication. The vehicle includes an autonomous driving system (ADS) having a memory in which an autonomous driving program is stored, and an ECU having a memory in which a control program for controlling a vehicle platform according to a request from the ADS is stored. The control center acquires a version of the autonomous driving program stored in the memory and a version of the control program stored in the memory and acquires operation guaranteed versions of both the programs, which are confirmed to be compatible with each other. In addition, the control center manages an update process of the control program such that the control program stored in the memory is updated within a range of the operation guaranteed version.

### CROSS-REFERENCE TO RELATED APPLICATION

This application claims priority to Japanese Patent Application No. 2021-183945 filed on Nov. 11, 2021, incorporated herein by reference in its entirety.

### BACKGROUND

### 1. Technical Field

The present disclosure relates to a vehicle management system, a server, a vehicle, and a vehicle management method, and more specifically to techniques for managing or controlling a vehicle capable of autonomous driving.

### 2. Description of Related Art

An autonomous driving system for realizing an autonomous driving function has been proposed. For example, the vehicle disclosed in Japanese Unexamined Patent Application Publication No. 2018-132015 includes a power system, an electric power supply system, and an autonomous driving system.

### SUMMARY

A vehicle capable of autonomous driving includes an autonomous driving system and a control device. The autonomous driving system has a memory in which an autonomous driving program is stored. The control device has a memory in which a control program that controls a vehicle platform according to a request from the autonomous driving system is stored.

Development of over-the-air (OTA) technology that updates various in-vehicle programs by wireless communication is underway. Both the autonomous driving program and the control program can be updated by OTA.

In the future, as autonomous driving technology advances, it is expected that vehicle platforms and autonomous driving systems will be manufactured by different manufacturers. Under such circumstances, it is possible to conceive of a situation in which the control program that controls the vehicle platform and the autonomous driving program will be updated separately. Even when the two types of programs are updated separately, it is desirable to properly link the vehicle platform and the autonomous driving system.

The present disclosure has been made to solve the above issue, and it is an object of the present disclosure to appropriately link a vehicle platform and an autonomous driving system.

(1) A vehicle management system according to a first aspect of the present disclosure includes a vehicle configured to perform autonomous driving, and a server configured to perform wireless communication with the vehicle. The vehicle includes a vehicle platform, an autonomous driving system having a first memory in which an autonomous driving program is stored, and a control device having a second memory in which a control program used for controlling the vehicle platform according to a request from the autonomous driving system is stored. The server is configured to acquire a version of the autonomous driving program stored in the first memory and a version of the control program stored in the second memory, acquire an operation guaranteed version of the autonomous driving program and an operation guaranteed version of the control program, which are confirmed to be compatible with each other. In addition, the server is configured to manage an update process of the control program such that the control program stored in the second memory is updated within a range of the operation guaranteed version.

In the above configuration (1), the server acquires the current versions of each of the autonomous driving program and the control program, and also acquires the operation guaranteed version. The above two types of programs are confirmed to be compatible with each other as long as it is within the range of the operation guaranteed version. Therefore, with the above configuration (1), the vehicle platform and the autonomous driving system can be appropriately linked by limiting the update of the control program to within the range of the operation guaranteed version.

(2) In the first aspect, the vehicle may further include a vehicle control interface configured to interface with the autonomous driving system and the control device. The vehicle control interface may collect the version of the autonomous driving program stored in the first memory from the autonomous driving system and collect the version of the control program stored in the second memory from the control device, and transmits the collected version to the server.

With the above configuration (2), the server can acquire various pieces of version information used for appropriately linking the vehicle platform and the autonomous driving system.

(3) In the first aspect, the vehicle management system may further include a terminal configured to communicate with the server. The server may inquire of the terminal as to whether the control program is updatable within the range of the operation guaranteed version. When a manager of the vehicle permits the update, the terminal may notify the server of the permission. Upon receiving the notification from the terminal, the server may manage the update process of the control program within the range of the operation guaranteed version.

In the above configuration (3), the control program can be updated after obtaining permission for updating from the manager of the vehicle.

(4) In the first aspect, the server does not have execute the update process of the control program when there is not an updatable control program within the range of the operation guaranteed version.

In the above configuration (4), when there is no updatable control program within the range of the guaranteed operation version, unnecessary arithmetic processing can be omitted by not executing the update process of the control program.

(5) A server according to a second aspect of the present disclosure manages an update process of a control program in a vehicle configured to perform autonomous driving. The vehicle includes a vehicle platform, an autonomous driving system having a first memory in which an autonomous driving program is stored, and a control device having a second memory in which a control program used for controlling the vehicle platform according to a request from the autonomous driving system is stored. The server includes a communication device configured to perform wireless communication with the vehicle, and a processor. The processor is configured to acquire a version of the autonomous driving program stored in the first memory and a version of the control program stored in the second memory, and acquire an operation guaranteed version of the autonomous driving program and an operation guaranteed version of the control program, which are confirmed to be compatible with each other. In addition, the processor is configured to manage an update process of the control program such that the control program stored in the second memory is updated within a range of the operation guaranteed version.

With the above configuration (5), similar to the above configuration (1), the vehicle platform and the autonomous driving system can be appropriately linked.

(6) A vehicle according to a third aspect of the present disclosure is configured to communicate with a server that manages a program update process via wireless communication. The vehicle includes a vehicle platform, an autonomous driving system having a memory in which an autonomous driving program is stored, a control device having a memory in which a control program used for controlling the vehicle platform according to a request from the autonomous driving system is stored, and a vehicle control interface configured to interface with the autonomous driving system and the control device. The vehicle control interface is configured to collect a version of the autonomous driving program stored in a first memory from the autonomous driving system and collects a version of the control program stored in a second memory from the control device, and transmits the collected version to the server.

With the above configuration (6), similar to the above configuration (2), it is possible to have the server acquire various pieces of version information used for appropriately linking the vehicle platform and the autonomous driving system.

(7) A vehicle management method according to a fourth aspect of the present disclosure is a management method by a server for a vehicle configured to perform autonomous driving. The vehicle includes an autonomous driving system having a first memory in which an autonomous driving program is stored, and a control device having a second memory in which a control program used for controlling a vehicle platform according to a request from the autonomous driving system is stored. The management method includes a first step to a third step. The first step is a step of acquiring a version of the autonomous driving program stored in the first memory and a version of the control program stored in the second memory. The second step is a step of acquiring an operation guaranteed version of the autonomous driving program and an operation guaranteed version of the control program, which are confirmed to be compatible with each other. The third step is a step of managing an update process of the control program such that the control program stored in the second memory is updated within a range of the operation guaranteed version.

With the above method (7), similar to the above configuration (1), the vehicle platform and the autonomous driving system can be appropriately linked.

With each aspect of the present disclosure, the vehicle platform and the autonomous driving system can be appropriately linked.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle management system according to an embodiment of the present disclosure;

FIG. 2 is a block diagram illustrating a typical hardware configuration of a vehicle;

FIG. 3 is a block diagram illustrating a typical hardware configuration of an autonomous driving system (ADS), a vehicle control interface box (VCIB), and an electronic control unit (ECU);

FIG. 4 is a block diagram illustrating a typical hardware configuration of a control center;

FIG. 5 is a first diagram for illustrating an outline of a program update process according to the present embodiment;

FIG. 6 is a second diagram for illustrating an outline of a program update process according to the present embodiment;

FIG. 7 is a sequence diagram illustrating a flow of processing until version information of a control program is acquired in the program update process; and

FIG. 8 is a sequence diagram illustrating a flow of processing from acquiring the version information of the control program to updating the control program in the program update process.

### DETAILED DESCRIPTION OF EMBODIMENTS

Hereinafter, an embodiment of the present disclosure will be described in detail with reference to the drawings. The same or corresponding parts in the drawings are designated by the same reference numerals, and the description thereof will not be repeated.

### EMBODIMENT

System Configuration

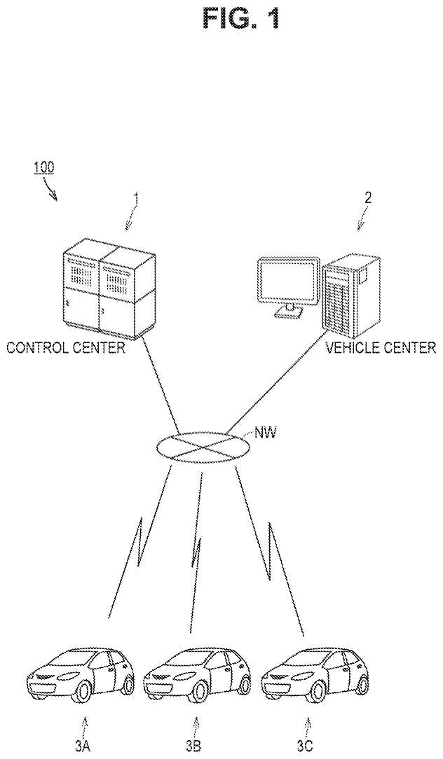

FIG. 1 is a diagram illustrating a schematic configuration of a vehicle management system according to an embodiment of the present disclosure. A vehicle management system 100 includes a control center 1, a vehicle center 2, and a plurality of vehicles 3A, 3B, and 3C. Hereinafter, for convenience of explanation, any one of the vehicles 3A, 3B, and 3C will be referred to as the vehicle 3. Although FIG. 1 shows three vehicles 3, the number of vehicles 3 is arbitrary.

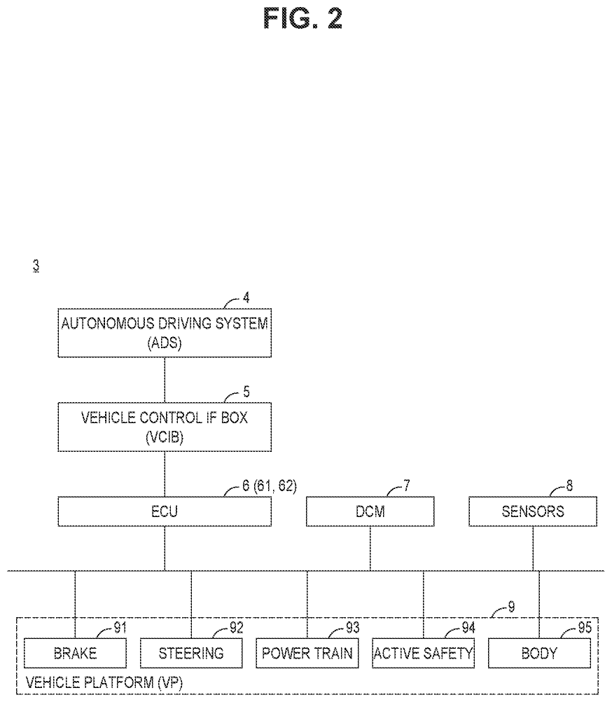

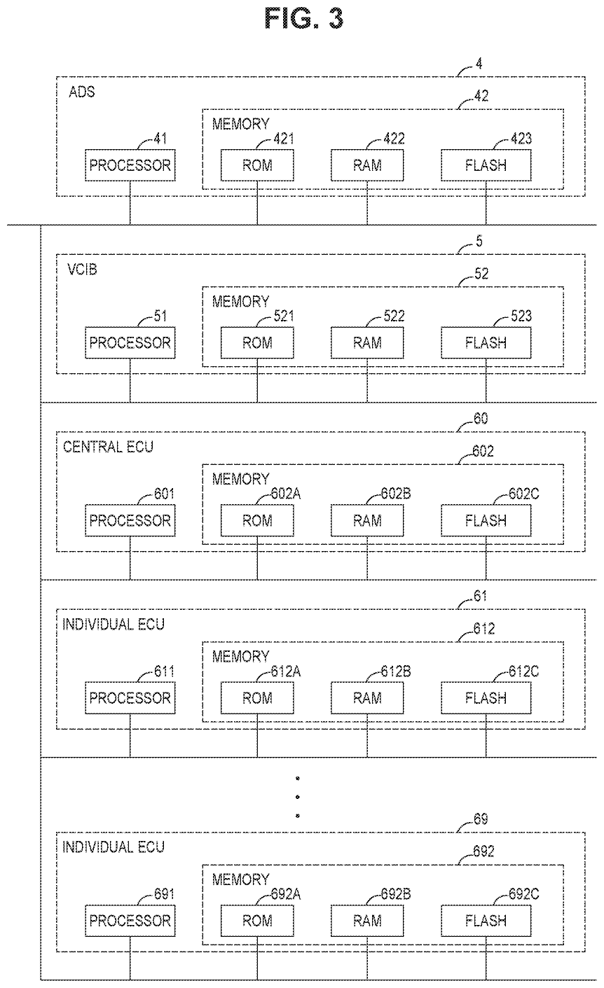

The control center 1 is a server of a business operator that provides a control program for an electronic control unit (ECU) 6 (see FIGS. 2 and 3) mounted on the vehicle 3. In this example, the control program for the ECU 6 is provided by the vehicle manufacturer. The control center 1 corresponds to a “server” according to the present disclosure.

The vehicle center 2 is, for example, an in-house server of a business operator (taxi business operator, ride sharing service business operator, and the like) that manages an operation of the vehicle 3. The vehicle center 2 may be a shared server shared by a plurality of business operators including the business operator. The vehicle center 2 may be a cloud server provided by a cloud server management company. The vehicle center 2 accepts operations by an operation manager of the vehicle 3. The operation manager is, for example, an employee who works for a business entity that manages the operation of the vehicle 3 and has the authority to update the control program of the vehicle 3.

Each of the plurality of vehicles 3 is an autonomous driving vehicle. Each vehicle 3 is used, for example, for a service provided by a business operator of the vehicle center 2. The type (vehicle type) of the vehicle 3 is appropriately selected according to the service provided by the business operator. The vehicle center 2, the control center 1, and each vehicle 3 are communicably connected to each other via a wired or wireless network NW.

The vehicle center 2 is not essential. When the vehicle 3 is not for business use but is privately owned, the vehicle management system 100 may include a user terminal (personal computer, smartphone, or the like) of the vehicle 3 instead of the vehicle center 2. The vehicle center 2 and/or the user terminal correspond to a “terminal” according to the present disclosure.

Vehicle Hardware Configuration

FIG. 2 is a block diagram illustrating a typical hardware configuration of the vehicle 3. The vehicle 3 includes an autonomous driving system (ADS) 4, a vehicle control interface box (VCIB) 5, an electronic control unit (ECU) 6, a data communication module (DCM) 7, a sensor group 8, and a vehicle platform (VP) 9. The components (each of the systems described above) of the vehicle 3 are connected to each other by a wired in-vehicle network such as a controller area network (CAN) or Ethernet (registered trademark). The ADS 4 and the ECU 6 are configured to be able to communicate with each other via the VCIB 5.

The ADS 4 outputs various control requests for realizing the autonomous driving of the vehicle 3 and receives various signals indicating the vehicle state (state of VP 9). More specifically, a traveling plan for the vehicle 3 is created. The ADS 4 outputs a control request for traveling of the vehicle 3 according to the traveling plan to the ECU 6 via the VCIB 5 according to an application program interface (API) defined for each control request. Further, the ADS 4 receives a signal indicating the vehicle state from the ECU 6 via the VCIB 5 according to the API defined for each signal. Then, the ADS 4 reflects the vehicle state in the traveling plan.

In addition, the ADS 4 is configured to update an autonomous driving program by wireless communication. In this example, an autonomous driving program is provided by the ADS manufacturer. The ADS 4 receives (downloads) the autonomous driving program from the ADS manufacturer via the DCM 7. The ADS 4 stores (installs) the downloaded autonomous operation program in a memory 42 (see FIG. 3) of the ADS 4 at an appropriate time. Then, the ADS 4 activates the installed autonomous driving program at an appropriate time.

The VCIB 5 is configured to be communicable with the ADS 4 through the CAN or the like. The VCIB 5 receives a control request from the ADS 4 and outputs the vehicle state to the ADS 4 by executing a predetermined API defined for each signal. When the VCIB 5 receives the control request from the ADS 4, the VCIB 5 outputs the control command corresponding to the control request to the system corresponding to the control command via the ECU 6. Further, the VCIB 5 acquires a signal indicating the vehicle state from each system via the ECU 6, and outputs the signal to the ADS 4.

The ECU 6 controls devices (each system included in the VP 9) related to the operation of the vehicle 3 in response to the control request from the ADS 4 and the signals from the sensor group 8. Further, the ECU 6 transmits various pieces of information (vehicle information) indicating the vehicle state to the vehicle center 2 and various requests to the vehicle center 2 via the DCM 7. Further, the ECU 6 receives a command or a notification from the vehicle center 2 via the DCM 7. The ECU 6 corresponds to a “control device” according to the present disclosure.

In addition, the ECU 6 is configured to update the control program of the VP 9 by wireless communication. More specifically, the ECU 6 receives (downloads) a control program from the control center 1 via the DCM 7. The ECU 6 stores (installs) the downloaded control program in a memory (described below) of the ECU 6 at an appropriate time. Then, the ECU 6 activates the installed control program at an appropriate time.

The DCM 7 is an in-vehicle communication module. The DCM 7 is configured to enable bidirectional data communication between the ECU 6 and the vehicle center 2 and bidirectional data communication between the ECU 6 and the control center 1.

The sensor group 8 includes a sensor configured to detect the external condition of the vehicle 3, and also includes sensors (none of which are illustrated) configured to detect information according to the traveling state of the vehicle 3 as well as a steering operation, an accelerator operation, and a braking operation. Specifically, the sensor group 8 may include, for example, a camera, a radar, a laser imaging detection and ranging (LIDAR), a vehicle speed sensor, an acceleration sensor, and a yaw rate sensor (none of which are illustrated). In addition, a part or all of the sensor group 8 may be contained in the ADS 4 or may be contained in the VP 9.

The VP 9 includes various systems that execute various vehicle controls according to the control request from the ADS 4. More specifically, the VP 9 includes a brake system 91, a steering system 92, a power train system 93, an active safety system 94, and a body system 95.

The brake system 91 is configured to control a braking device (not illustrated) provided on each vehicle wheel of the VP 9. Braking devices include, for example, a disc brake system that operates in response to hydraulic pressure adjusted by an actuator.

The steering system 92 is configured to control a steering angle of a steered wheel of the vehicle 3 by using a steering device. The steering device includes, for example, an electric power steering (EPS) whose steering angle can be adjusted by an actuator.

The power train system 93 includes, for example, an electric parking brake (EPB) system, a parking lock (P-Lock) system, and a shift device (none of which are illustrated) configured to select a shift range.

The active safety system 94 detects obstacles (pedestrians, bicycles, parked vehicles, electric poles, and the like) in front of or behind the vehicle 3 using cameras, radars, sensors, and the like. The active safety system 94 determines whether there is a possibility that the vehicle 3 will collide with the obstacle based on a distance between the vehicle 3 and the obstacle and a moving direction of the vehicle 3. When the active safety system 94 determines that there is a possibility of a collision, the active safety system 94 outputs a braking command to the brake system 91 such that the braking force is increased.

The body system 95 is configured to control parts (none of which are illustrated) such as a turn signal, a horn, and a wiper according to, for example, the traveling state or the environment of the vehicle 3.

Hardware Configuration of ADS, VCIB, and ECU

FIG. 3 is a block diagram illustrating a typical hardware configuration of the ADS 4, the VCIB 5, and the ECU 6. The ECU 6 includes a central ECU 60 and individual ECUs 61 to 69. The number of individual ECUs illustrated in FIG. 3 is merely an example, and the ECU 6 may include an arbitrary number of individual ECUs.

The ADS 4 includes a processor 41 and a memory 42. The memory 42 includes a read only memory (ROM) 421, a random access memory (RAM) 422, and a flash memory 423. The flash memory 423 (first memory) stores an autonomous driving program executed by the processor 41. The autonomous driving program can be updated by OTA.

The VCIB 5 includes a processor 51 and a memory 52. The memory 52 includes a ROM 521, a RAM 522, and a flash memory 523.

The central ECU 60 includes a processor 601 and a memory 602. The memory 602 includes a ROM 602A, a RAM 602B, and a flash memory 602C. The individual ECU 61 includes a processor 611 and a memory 612. The memory 612 includes a ROM 612A, a RAM 612B, and a flash memory 612C. Since the same applies to the remaining individual ECUs 62 to 69, the description thereof will not be repeated.

Since the configurations of the individual ECUs 61 to 69 are basically the same, the individual ECU 61 will be typically described below. The flash memory 612C (second memory) of the individual ECU 61 stores a control program executed by the processor 611 of the individual ECU 61. This control program can also be updated by OTA. The individual ECU 61 uses the control program to control the corresponding system from among the various systems included in the VP 9. The central ECU 60 controls the update process (OTA) of the control program stored in the individual ECU 61.

Hardware Configuration of Control Center

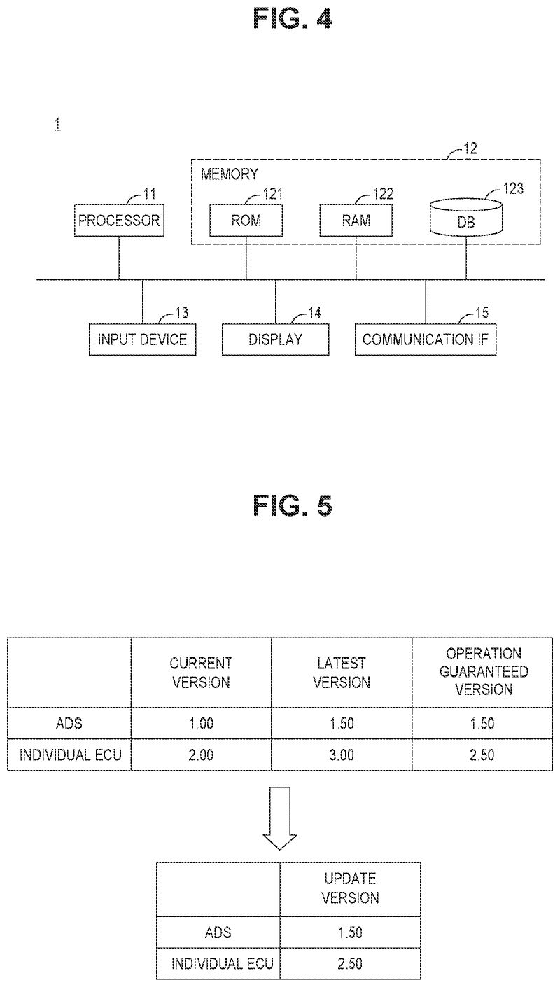

FIG. 4 is a block diagram illustrating a typical hardware configuration of the control center 1. The control center 1 includes a processor 11, a memory 12, an input device 13, a display 14, and a communication interface (IF) 15. The memory 12 includes a ROM 121, a RAM 122, and a database 123.

The processor 11 controls the overall operation of the control center 1. The memory 12 (ROM 121) stores an operating system and an application program executed by the processor 11. The input device 13 receives the input of an administrator of the control center 1. The input device 13 is typically a keyboard and a mouse. The display 14 displays information. The communication IF 15 is an interface for communicating with the vehicle center 2 and the vehicle 3.

In the present embodiment, the database 123 stores various pieces of information (various pieces of version information described below) for storing the control programs of the individual ECUs 61 to 69 of the vehicle 3. The control center 1 can provide the information used in a control program update process to the central ECU 60 by referring to the database 123.

Program Compatibility

As described above, in the present embodiment, the autonomous driving program of the ADS 4 is provided by the ADS manufacturer, while the control program of the individual ECU 61 is provided by the vehicle manufacturer. That is, the autonomous driving program of the ADS 4 and the control program of the individual ECU 61 are provided by different business operators. Therefore, the update time of the autonomous driving program and the update time of the control program may be different. Then, depending on the combination of the autonomous driving program and the control program, the two types of programs may not be sufficiently compatible. As a result, the ADS 4 and the VP 9 (more specifically, a system in the VP 9 controlled using the control program of the individual ECU 61) may not be able to properly cooperate with each other.

Therefore, in the present embodiment, the control center 1 acquires the version information of both the autonomous driving program and the control program. Then, the control center 1 updates the control program of the individual ECU 61 to be within the range of the combination of the two types of programs for which the operation is guaranteed as a result of the verification work performed separately. In order to facilitate understanding, a specific example of the program update process in the present embodiment will be described below.

FIG. 5 is a first diagram for illustrating an outline of a program update process in the present embodiment. In this example, it is assumed that the current version of the autonomous driving program of the ADS 4 is 1.00 and the current version of the control program of the individual ECU 61 is 2.00. Further, it is assumed that the latest version of the autonomous driving program of the ADS 4 is 1.50, and the latest version of the control program of the individual ECU 61 is 3.00.

The control center 1 has the verification result regarding the compatibility between the autonomous driving program of the ADS 4 and the control program of the individual ECU 61. More specifically, for each combination of the autonomous driving program version and the control program version, the vehicle manufacturer carries out verification work on various predetermined items relating to whether the combination causes any trouble in the operation of the VP 9 and whether the ADS 4 and the VP 9 can be appropriately linked. The control center 1 acquires the verification carried out by the vehicle manufacturer from the vehicle manufacturer. In the example illustrated in FIG. 5, the verification work has been completed up to the combination of the autonomous driving program version 1.50 and the control program version 2.50, and the verification result that the ADS 4 and the VP 9 can be appropriately linked has been obtained. In other words, the vehicle manufacturer guarantees the operation up to the combination described above. Hereinafter, the version whose operation is guaranteed is referred to as “operation guaranteed version”. Information about the operation guaranteed version is stored in the database 123 (see FIG. 4).

It is also conceivable to update each of the autonomous driving programs of the ADS 4 and the control program of the individual ECU 61 to the latest version. In this example, it is conceivable to update the autonomous driving program from version 1.00 to 1.50 and the control program from version 2.00 to 3.00. However, since the verification work has not been completed for the version exceeding the operation guaranteed version, there is a possibility that the ADS 4 and the VP 9 cannot be properly linked when the version is updated to the latest version.

In the present embodiment, the control center 1 does not update the control program of the individual ECU 61 up to the latest version, but only updates it up to the operation guaranteed version. In this example, the control center 1 updates the control program of the individual ECU 61 only from version 2.00 to 2.50. On the other hand, since the operation of the autonomous driving program of the ADS 4 is guaranteed up to the latest version (1.50), the version 1.00 is updated to 1.50.

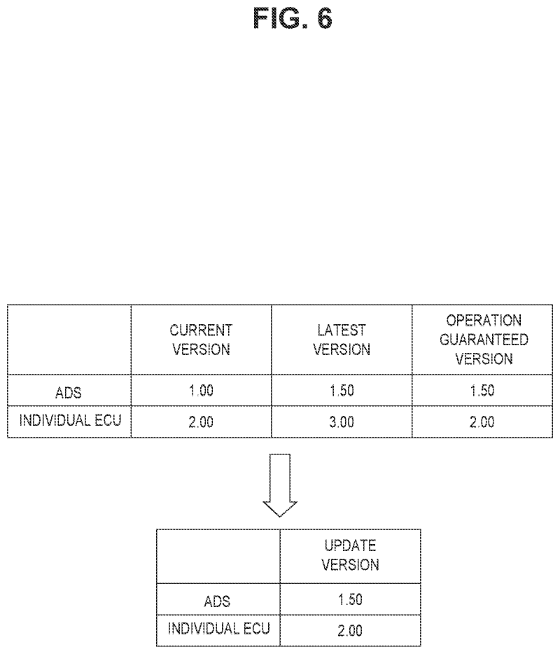

FIG. 6 is a second diagram for illustrating an outline of the program update process in the present embodiment. This example differs from the example described in FIG. 4 in that the operation guaranteed version of the control program of the individual ECU 61 is 2.00 instead of 2.50. In other words, in this example, the operation of the control program is guaranteed only up to the current version. In this case, the control center 1 does not update the control program of the individual ECU 61 to the current version. On the other hand, the autonomous driving program of the ADS 4 is updated to the latest version.

Process Sequence

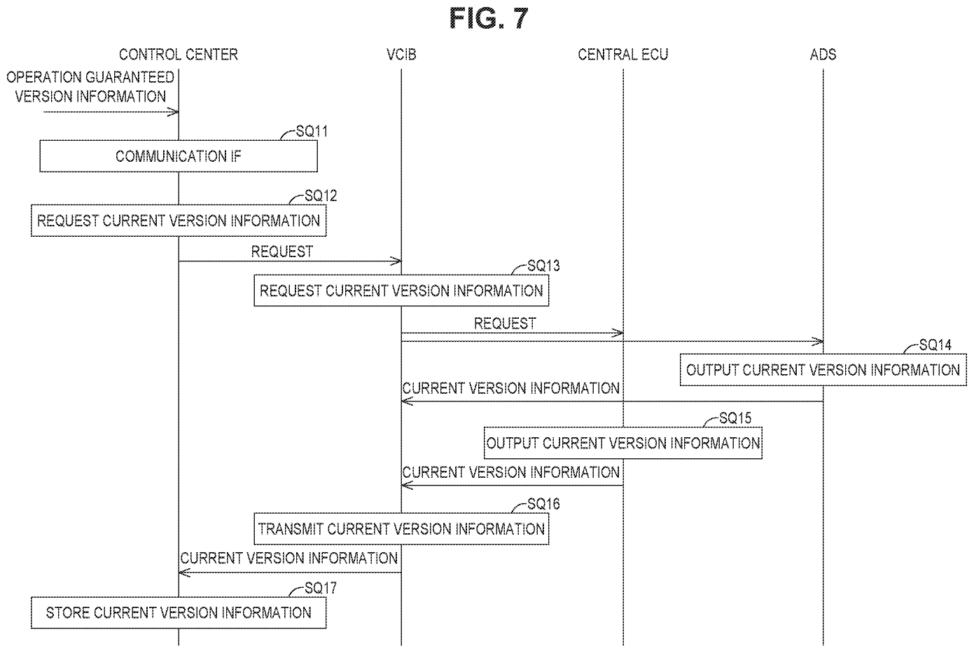

FIG. 7 is a sequence diagram illustrating a process flow until the version information of the control program is acquired in the program update process. This sequence diagram is executed when a predetermined condition is satisfied (for example, when the control center 1 can provide a new control program). In the figure, the processes executed by the control center 1, the processes executed by the VCIB 5, the processes executed by the central ECU 60, and the processes executed by the ADS 4 are shown in order from left to right.

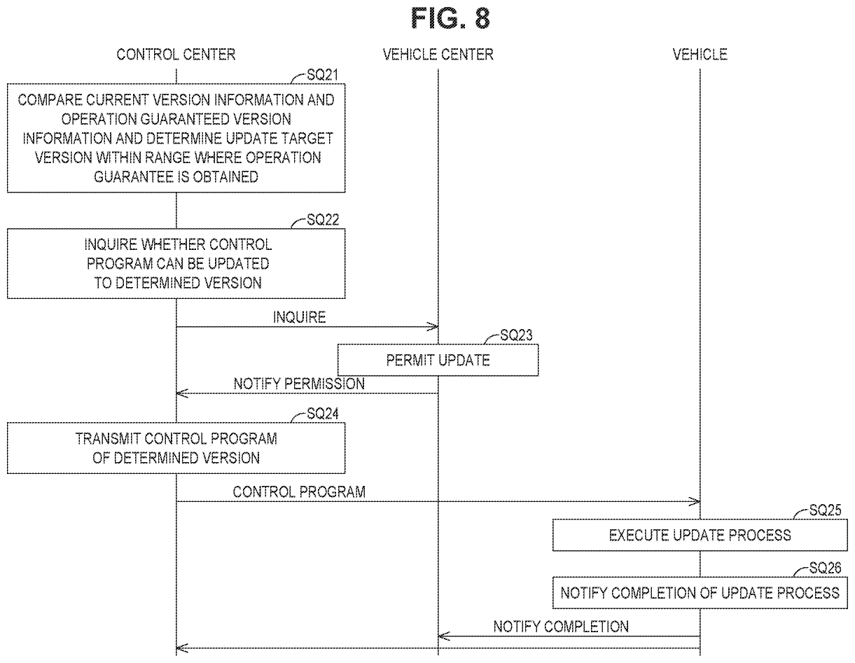

Each sequence included in the sequence diagram of FIG. 7 is executed by software processing carried out by the control center 1, the vehicle center 2, or the vehicle 3 (ECU 6 or VCIB 5), but may be executed by hardware (electric circuit). The same applies to the sequence diagram of FIG. 8 described below. Hereinafter, the sequence is abbreviated as SQ.

In SQ11, the control center 1 acquires the operation guaranteed version information based on the verification carried out by the vehicle manufacturer from the vehicle manufacturer and stores it in the database 123. The acquisition destination of the operation guaranteed version information is not particularly limited to the vehicle manufacturer, and may be, for example, a third party organization (compatibility-related inspection organization, certification organization, or the like) different from the vehicle manufacturer and the ADS manufacturer.

In SQ12, the control center 1 requests the VCIB 5 via the communication IF 15 for information about the current version (version of the autonomous driving program stored in the flash memory 423) of the autonomous driving program of the ADS 4 and the current version (version of the control program stored in the flash memories 602C to 692C) of each control program of the individual ECUs 61 to 69. Hereinafter, these pieces of version information will also be referred to as “current pieces of version information”.

Upon receiving the request from the control center 1, the VCIB 5 requests the ADS 4 for the current pieces of version information of the autonomous driving program of the ADS 4 (not illustrated), and also requests the central ECU 60 for the current pieces of version information of the control programs of the individual ECUs 61 to 69 (SQ13).

The ADS 4 outputs the current pieces of version information of the autonomous driving program to the VCIB 5 in response to the request from the VCIB 5 (SQ14). Similarly, the central ECU 60 outputs the current pieces of version information of the control program of each individual ECU 61 to 69 to the VCIB 5 in response to the request from the VCIB 5 (SQ15). As a result, the current pieces of version information of all programs is collected in the VCIB 5. The VCIB 5 may collect the current pieces of version information on a regular basis, for example, regardless of whether there is a request from the control center 1.

In SQ16, the VCIB 5 transmits the collected current pieces of version information of the autonomous driving program and the current pieces of version information of the control program to the control center 1 via the DCM 7. When the control center 1 acquires the above-described two pieces of current version information from the VCIB 5, it stores the acquired current pieces of version information in the database 123 (SQ17).

FIG. 8 is a sequence diagram illustrating a process flow from acquiring the version information of the control program to updating the control program in the program update process. This sequence diagram is executed after the sequence diagram illustrated in FIG. 7 is executed. In the figure, the processes executed by the control center 1, the processes executed by the vehicle center 2, and the processes executed by the vehicle 3 (central ECU 60) are shown in order from left to right.

In SQ21, the control center 1 compares the current pieces of version information stored in the database 123 with the operation guaranteed version information, and determines to which version the control program is updated within a range where the operation guarantee is obtained. As described with reference to FIGS. 4 and 5, it is desirable that the control center 1 determines that the control program be updated to the version closest to the latest version within the range where the operation guarantee is obtained.

In SQ22, the control center 1 inquires of the vehicle center 2 as to whether the control program can be updated to the version determined in SQ21. Upon receiving the inquiry, an operation manager of the vehicle 3 performs an operation (for example, an operation of pressing the “Update” icon) for permitting the update to an input device (not illustrated) such as a keyboard and a mouse (SQ23). Then, the vehicle center 2 notifies the control center 1 that the operation manager has approved the update of the control program. When the operation manager refuses to update (for example, when the operation manager presses “No” icon), the control center 1 is notified and the subsequent update process is not executed.

In SQ24, the control center 1 transmits the control program of the version (=the version obtained the permission of the operation manager) determined in SQ21 to the vehicle 3. The central ECU 60 executes the update process of the control program of the individual ECU 61. That is, the central ECU 60 receives (downloads) the control program from the control center 1 and stores (installs) the program in the flash memory 612C of the individual ECU 61. Then, the central ECU 60 activates the installed control program at an appropriate time. When the update process of the control program of the individual ECU 61 is normally completed, the central ECU 60 notifies the control center 1 and the vehicle center 2 of the completion (SQ26).

As described above, in the present embodiment, when updating the control program stored in the individual ECUs 61 to 69 by OTA, instead of simply updating to the latest version, only updating to the version (operation guaranteed version) whose operation is guaranteed by the vehicle manufacturer or the like is approved. Regarding the combination of the operation guaranteed version of the autonomous driving program and the control program, as a result of verification work carried out by the vehicle manufacturer, or the like, it has been confirmed that the autonomous driving program and the control program are sufficiently compatible. Therefore, according to the present embodiment, the VP 9 and the ADS 4 can be appropriately linked without any trouble.

The embodiment disclosed herein should be considered to be exemplary and not restrictive in all respects. The scope of the present disclosure is set forth by the claims rather than the description of the embodiment described above, and is intended to include all modifications within the meaning and scope of the claims.

What is claimed is:

1. A vehicle management system comprising:
a vehicle configured to perform autonomous driving; and
a server configured to perform wireless communication with the vehicle, wherein the vehicle includes
a vehicle platform,
an autonomous driving system having a first memory in which an autonomous driving program is stored, and
a control device having a second memory in which a control program used for controlling the vehicle platform according to a request from the autonomous driving system is stored, and
wherein the server is configured to:
acquire a version of the autonomous driving program stored in the first memory and a version of the control program stored in the second memory;
acquire an operation guaranteed version of the autonomous driving program and an operation guaranteed version of the control program, which are confirmed to be compatible with each other; and
manage an update process of the control program such that the control program stored in the second memory is updated within a range of the operation guaranteed version.

2. The vehicle management system according to claim 1, wherein:
the vehicle further includes a vehicle control interface configured to interface with the autonomous driving system and the control device; and
the vehicle control interface is configured to collect the version of the autonomous driving program stored in the first memory from the autonomous driving system and collect the version of the control program stored in the second memory from the control device, and transmit the collected versions to the server.

3. The vehicle management system according to claim 1, further comprising a terminal configured to communicate with the server, wherein:
the server is configured to inquire of the terminal as to whether the control program is updatable within the range of the operation guaranteed version;
the terminal is configured to, when a manager of the vehicle permits an update, notify the server of the permission; and
the server is configured to, upon receiving the notification from the terminal, manage the update process of the control program within the range of the operation guaranteed version.

4. The vehicle management system according to claim 1, wherein the server is configured to not execute the update process of the control program when there is not an updatable control program within the range of the operation guaranteed version.

5. A server that manages an update process of a control program in a vehicle configured to perform autonomous driving,
wherein the vehicle includes
a vehicle platform,
an autonomous driving system having a first memory in which an autonomous driving program is stored, and
a control device having a second memory in which a control program used for controlling the vehicle platform according to a request from the autonomous driving system is stored,
wherein the server includes
a communication device configured to perform wireless communication with the vehicle, and
a processor, and
wherein the processor is configured to:
acquire a version of the autonomous driving program stored in the first memory and a version of the control program stored in the second memory;
acquire an operation guaranteed version of the autonomous driving program and an operation guaranteed version of the control program, which are confirmed to be compatible with each other; and
manage an update process of the control program such that the control program stored in the second memory is updated within a range of the operation guaranteed version.

6. A vehicle which is configured to communicate with a server that manages a program update process via wireless communication, the vehicle comprising:
a vehicle platform;
an autonomous driving system having a memory in which an autonomous driving program is stored;
a control device having a memory in which a control program used for controlling the vehicle platform according to a request from the autonomous driving system is stored; and
a vehicle control interface configured to interface with the autonomous driving system and the control device, and
wherein the vehicle control interface is configured to collect a version of the autonomous driving program stored in a first memory from the autonomous driving system and collect a version of the control program stored in a second memory from the control device, and transmit the collected versions to the server.

7. A management method by a server for a vehicle configured to perform autonomous driving,
wherein the vehicle includes
an autonomous driving system having a first memory in which an autonomous driving program is stored, and
a control device having a second memory in which a control program used for controlling a vehicle platform according to a request from the autonomous driving system is stored, and
wherein the management method includes:
acquiring a version of the autonomous driving program stored in the first memory and a version of the control program stored in the second memory;
acquiring an operation guaranteed version of the autonomous driving program and an operation guaranteed version of the control program, which are confirmed to be compatible with each other; and
managing an update process of the control program such that the control program stored in the second memory is updated within a range of the operation guaranteed version.
